(19) United States
(12) Patent Application Publication
(10) Pub. No.: US 2003/0017230 A1
(43) Pub. Date: Jan. 23, 2003

(54) Clamping unit

(76) Inventors: Akira Yoshinaga, Numazu-shi (JP); Tatsuhiko Maru, Shizuoka-ken (JP); Jun Koike, Shizuoka-ken (JP); Fumiyuki Kato, Shizuoka-ken (JP); Makoto Nishizawa, Numazu-shi (JP)

Correspondence Address: PILLSBURY WINTHROP, LLP, P.O. BOX 10500, MCLEAN, VA, 22102, US

(21) Appl. No.: 10/193,154

(22) Filed: Jul. 12, 2002

(30) Foreign Application Priority Data
Jul. 18, 2001 (JP) 2001-218402
Oct. 30, 2001 (JP) 2001-332242

(51) Int. Cl. B29C 45/38

(52) U.S. Cl. 425/589

(57) ABSTRACT

Provided is a clamping unit for die clamping with a die-clamping force directly applied to dies consisting of a stationary die and a movable die, including a stationary platen for holding the stationary die, a movable platen for holding the movable die, the movable platen being disposed opposite to the stationary platen, and a linear guiding system for guiding the movement of the movable platen.

### CROSS-REFERENCE TO RELATED APPLICATIONS

This application is based upon and claims the benefit of priority from the prior Japanese Patent Applications No. 2001-218402, filed Jul. 18, 2001; and No. 2001-332242, filed Oct. 30, 2001, the entire contents of both of which are incorporated herein by reference.

### BACKGROUND OF THE INVENTION

1. Field of the Invention

The present invention relates to a clamping unit of an injection molding machine and, particularly, to a clamping unit for die clamping with a die-clamping force directly applied to dies consisting of a stationary die and a movable die. More particularly, it relates to an electric direct-acting clamping unit in which the driving force from a driving source is transmitted to a movable platen without using a toggle link mechanism.

2. Description of the Related Art

FIG. 13 is a schematic representation of a conventional clamping unit. A stationary platen 53 which holds a stationary die 55 is disposed at the right-hand end of a base plate 51. A movable platen 54 which holds a movable die 56 is disposed opposite to the stationary platen 53. On the base plate 51 is attached a sliding plate 57 which can slidably support the movable platen 54. A load cell 62 is fixed to the rear face of the movable platen 54. The leading end portion of a ball screw shaft 60 is fixed to the rear face of the load cell 62. A nut 61 is attached to the ball screw shaft 60. On the left-hand side of the base 51 is disposed a backup plate 52 in such a manner that the tail end of the ball screw shaft 60 pierces the backup plate 52. In front of the backup plate 52 is disposed a housing 58 which rotatably supports the nut 61 via a bearing 63. There is provided a pair of upper and lower coil springs for connecting the housing 58 to the backup plate 52.

A motor 65 is housed below the base plate 51. A pulley 66 is attached to the shaft of the motor 65. A pulley 67 is attached to the end face of the nut 61 of the ball screw (the end face facing the movable die 56). A timing belt 68 bridges the pulleys 66 and 67. In die clamping, the nut 61 is rotated by the rotation of the motor 65. As a result, the ball screw shaft 60 is delivered rightward to advance the movable platen 54 toward the stationary platen 53.

In the conventional clamping unit, a sliding plate 57 is used on the sliding surface of a leg portion 54a of the movable platen 54. The sliding plate 57 can not restrain the torsional moment generated by the rotation 69 of the nut 61 during die clamping. As a result, the moving plate 54 is twisted (rotated) or laterally shifted and an accurate die-clamping force can not be obtained. Moreover, the movable die 56 also rotates along with the movable platen 54. For this reason, a deviation occurs between the stationary die 55 and the movable die 56, and the dies 55, 56 rub together and bite into each other, with the result of a shorter life of the dies 55, 56. Moreover, the rotation of the movable die 56 makes it difficult to stably form precision molded articles. Furthermore, excessive loads acting on the components of the clamping unit shorten their life.

### BRIEF SUMMARY OF THE INVENTION

The object of the present invention is to provide a clamping unit which permits an improvement in the die clamping accuracy, protection of dies, extension of die life and stable precision molding by solving the above-described problems and eliminating the twist and shift of a movable platen due to the rotation of a ball screw shaft.

In order to solve the above-described problems, according to an aspect of the invention, there is provided a clamping unit for die clamping with a die-clamping force directly applied to dies consisting of a stationary die and a movable die, which comprises: a stationary platen for holding the above-described stationary die; a movable platen for holding the above-described movable die, which is disposed opposite to the above-described stationary platen; and a linear guiding system for guiding the movement of the above-described movable platen.

According to another aspect of the invention, there is also provided a clamping unit for die clamping with a die-clamping force directly applied to dies consisting of a stationary die and a movable die, which comprises: a base; a stationary platen for holding the above-described stationary die, which is disposed on one side of the above-described base; a movable platen for holding the above-described movable die, which is disposed opposite to the above-described stationary platen; a linear guiding system for guiding the movement of the above-described movable platen, which is provided on the above-described base; a backup plate disposed on the other side of the above-described base; a housing disposed in front of the above-described backup plate; an elastic member for connecting the above-described backup plate and the above-described housing, which is capable of expansion and contraction in the die-clamping direction; a ball screw for connecting the above-described housing and the above-described movable platen, the ball screw having a screw shaft of which the leading end is fixed to the rear face of the above-described movable platen and a nut which is rotatably housed in the above-described housing; and a motor for rotating the above-described nut of the ball screw housed in the above-described housing.

According to a further aspect of the invention, there is provided a clamping unit for die clamping with a die-clamping force directly applied to dies consisting of a stationary die and a movable die, which comprises: a base; a stationary platen for holding the above-described stationary die, which is disposed on the above-described base; a movable platen for holding the above-described movable die, which is disposed opposite to the above-described stationary platen; a linear guiding system for guiding the movement of the above-described movable platen, which is provided on the above-described base; a backup plate for supporting the above-described movable platen at the rear face; a plurality of ball screws for connecting the above-described stationary platen and the above-described backup plate, each ball screw having a screw shaft of which the leading end is rotatably connected to the above-described stationary platen and a nut fixed to the above-described backup plate; and a motor for rotating the above-described screw shafts of the plurality of ball screws in synchronization with each other.

Also, according to still another aspect of the invention, there is provided a clamping unit for die clamping with a die-clamping force directly applied to dies consisting of a stationary die and a movable die, which comprises: a base; a stationary platen for holding the above-described stationary die, which is disposed on the above-described base; a movable platen for holding the above-described movable die, which is disposed opposite to the above-described stationary platen; a linear guiding system for guiding the movement of the above-described movable platen, which is provided on the above-described base; a backup plate disposed at the rear of the above-described movable platen; an elastic member for connecting the above-described movable platen and the above-described backup plate, which is capable of expansion and contraction in the die-clamping direction; a plurality of ball screws for connecting the above-described stationary platen and the above-described backup plate, each ball screw having a screw shaft of which the leading end is rotatably connected to the above-described stationary platen and a nut fixed to the above-described backup plate; and a motor for rotating the above-described screw shafts of the plurality of ball screws in synchronization with each other.

According to the features of the invention as described above, the movement of the movable platen with the linear guiding system can eliminate the twist and shift of the movable platen due to the rotation of the screw shaft during die clamping.

In the invention, it is preferred that the linear guiding system be a linear guide. The linear guide comprises a linear guide rail provided on the base and a slider which sandwiches both side faces of the guide rail by means of rotatable elements. The slider is attached to the bottom portion of the above-mentioned movable platen.

In the invention, it is preferred that the linear guiding system be a linear V-shaped groove having a V-shaped section provided on the base. The V-shaped groove receives a convex member having a V-shaped section provided on the above-mentioned movable platen.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of the invention.

FIG. 1 is a general configuration view of a first embodiment of a clamping unit of the invention.

FIG. 2 is a left sectional view along the line II-II in FIG. 1 showing one form of a movable platen using a linear guide as a linear guiding system of the invention.

FIG. 3 is a left sectional view along the line II-II in FIG. 1 showing another form of a movable platen using a V-shaped guide as a linear guiding system of the invention.

FIG. 4 is a schematic front view of a second embodiment of a clamping unit of the invention.

FIG. 5 is a schematic, longitudinal sectional view of a second embodiment of a clamping unit of the invention, as viewed parallel to the axial direction of the unit.

FIG. 6 is a left side view of one form of a movable platen of the invention.

FIG. 7 is a detailed side view of a connection portion between a motor and a screw shaft of the invention.

FIG. 8 is a partial detailed view of a ball screw of the invention, the view corresponding to Section VIII-VIII of FIG. 7.

FIG. 9 is a left side view of another form of a movable platen of the invention.

FIG. 10 is a schematic front view of a third embodiment of a clamping unit of the invention.

FIG. 11 is a schematic, longitudinal sectional view of a third embodiment of a clamping unit of the invention, as viewed parallel to the axial direction of the unit.

FIG. 12 is a detailed view of a connection portion between a backup plate and a movable platen of the invention.

FIG. 13 is a schematic representation of a conventional clamping unit.

FIG. 14 is a left sectional view along the line XIV-XIV in FIG. 13 showing the movement of a movable platen with a sliding plate provided on a base of a conventional clamping unit.

### DETAILED DESCRIPTION OF THE INVENTION

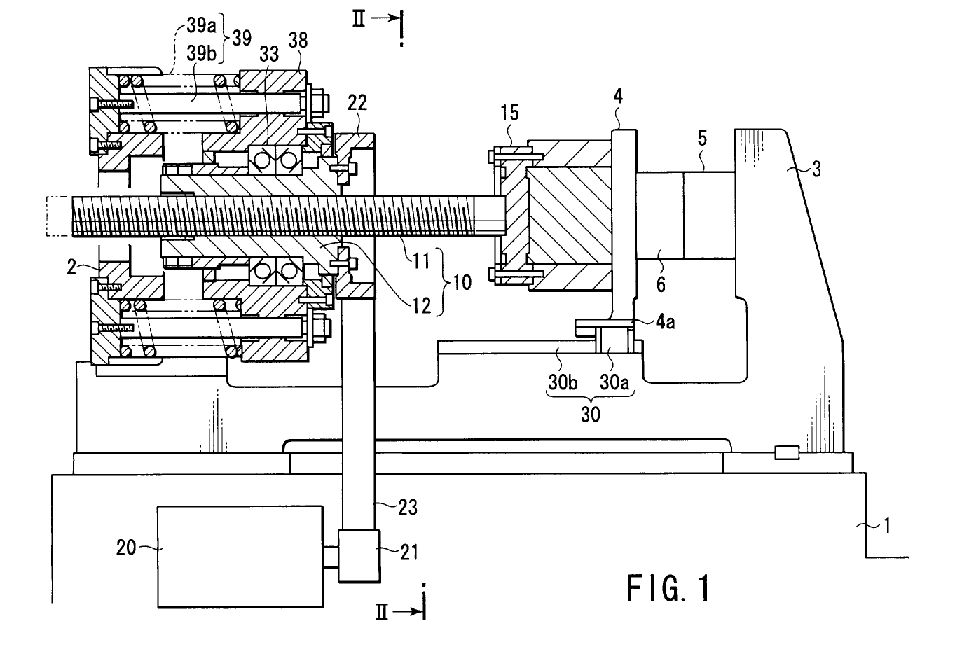

Embodiments of the present invention will be described below by referring to FIGS. 1 to 3. FIG. 1 is a general configuration view of a first embodiment of a clamping unit of the invention. At both ends of a base 1 are disposed a backup plate 2 and a stationary platen 3 so as to be opposed to each other. Between the backup plate 2 and the stationary platen 3 is disposed a movable platen 4 opposite to the stationary platen 3. A stationary die 5 is held at the front face of the stationary platen 3. A movable platen 6 is held at the front face of the movable platen 4.

A load cell 15 is fixed to the rear face of the movable platen 4. The leading end of a ball screw shaft 11 of a ball screw 10 is fixed to the rear face of the load cell 15. A nut 12 is attached to the ball screw shaft 11. The tail end portion of the ball screw 11 pierces the backup plate 2.

A housing 38 is disposed in front of the backup plate 2. The housing 38 rotatably supports the nut 12 via a bearing 33 and houses the nut 12. A pair of upper and lower coil springs 39 (elastic bodies) is connected to the housing 38. Each coil spring 39 consists of a spring 39a and a guide bar 39b fixed to the center of the spring 39a. The guide bar 39b guides the spring 39a in such a manner that the spring 39a expands and contracts parallel to the ball screw shaft 11.

A servomotor 20 is housed below the base 1. A pulley 21 is attached to the shaft of the servomotor 20. A pulley 22 is attached to the right-hand end face of the nut 12. A timing belt 23 bridges the pulley 21 and the pulley 22. The nut 12 is rotated by the rotation of the servomotor 20 and the ball screw shaft 11 is axially driven by this rotation of the nut 12. As a result, a leg portion 4a attached to the lower part of the movable platen 4 can move in the backward and forward directions with being guided by a linear guiding system, for example, a linear guide 30, which is provided on the base 1.

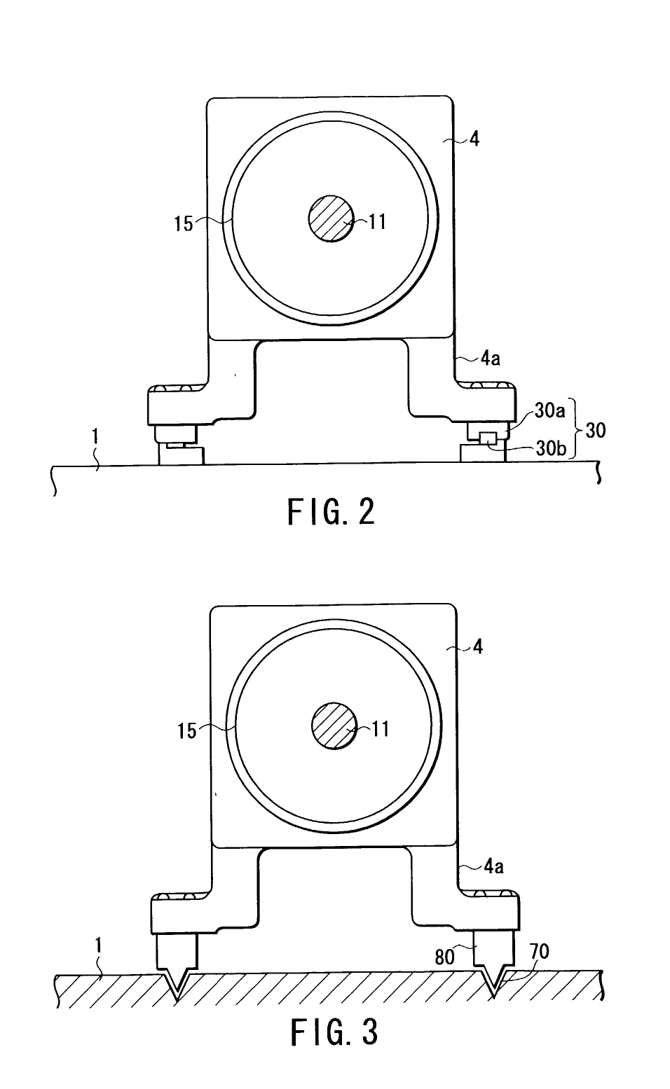

FIG. 2 is a sectional view of one form of a movable platen 4 when the linear guide 30 is used as a linear guiding system of the invention. The view is taken along the line II-II in FIG. 1 and shows only left-hand portion. The linear guide 30 consists of a linear guide rail 30b, which is provided on the base 1, and a slider 30a, which is attached to the bottom portion (leg portion 4a) of the movable platen 4. The slider 30a can sandwich the guide rail 30b from its both side faces by use of rotatable elements, such as balls and rollers. The linear guide 30 enables the movable platen 4, together with the slider 30a, to move linearly along the guide rail 30b.

FIG. 3 is a sectional view of another form of a movable platen 4 when a V-shaped groove having a V-shaped section is used in place of the linear guide 30 as a linear guiding system. The view is taken along the line II-II in FIG. 1 and shows only left-hand portion. A linear guide grove 70 (a V-shaped groove) is provided on the surface of the base 1. On the bottom portion (leg portion 4a) of the movable platen 4, is provided a convex member 80 having a V-shaped section corresponding to the guide groove 70. The convex portion of the convex member 80 is inserted into the guide groove 70 and moved along the groove 70. In this manner the movable platen 4 can move linearly along the guide groove 70.

Next, the operation of the unit of the invention will be described below. During die clamping, the pulley 21 is rotated by driving the servomotor 20. As a result of this rotation, the pulley 22 is rotated via the timing belt 23 bridging the pulleys 21, 22. The rotation of the pulley 22 rotates the nut 12 and the ball screw shaft 11 is delivered rightward in FIG. 1. The movable platen 4, which is connected to the ball screw shaft 11 via the load cell 15, advances toward the stationary platen 3. The movable platen 4 moves linearly on the base 1 by means of the linear guide 30. As described above, the operation of die clamping and die opening is performed by the drive of the ball screw 10.

During die clamping, the screw ball 10 is driven to advance the movable platen 4 toward the stationary platen 3, and the die faces of the stationary die 5 and movable die 6 are thus brought into contact with each other. The reaction force of the die-clamping force (compressive load generated on the die faces) which the movable die 6 receives upon contact, is transmitted to the housing 38 via the movable platen 4 and ball screw shaft 11. The coil springs 39 contract in this manner.

The slider 30a of the linear guide 30 sandwiches the guide rail 30b from its both side faces. For this reason, the movable platen 4 moves only in the moving direction along the guide rail 30b. Therefore, differently from the case where the guide face comprises a sliding plate, the linear guide 30 can restrain a torsional moment generated in the movable platen 4. The torsional moment is generated on the movable platen 4 in both rotative directions by the forward and reverse rotations of the nut 12 of the ball screw 10.

As a result of the restraint of the torsional moment of the movable platen 4, the following effects are produced. 1) The twist (rotation) and lateral shift of the movable platen 4 do not occur any more. For this reason, an accurate die-clamping force is obtained. 2) The movable die 6 does not rotate together with the movable platen 4. For this reason, no shift is generated between the two dies 5, 6 and rubbing or galling between the two dies 5, 6 does not occur. Therefore, the life of the two dies is extended. Furthermore, because the movable die 6 does not rotate, it is possible to perform stable precision molding.

Even when the guide groove 70 is used in place of the linear guide 30, the torsional moment generated by the rotation of the nut 12 can be restrained by the guide groove 70. As a result, it is possible to obtain the above-described accurate die-clamping force.

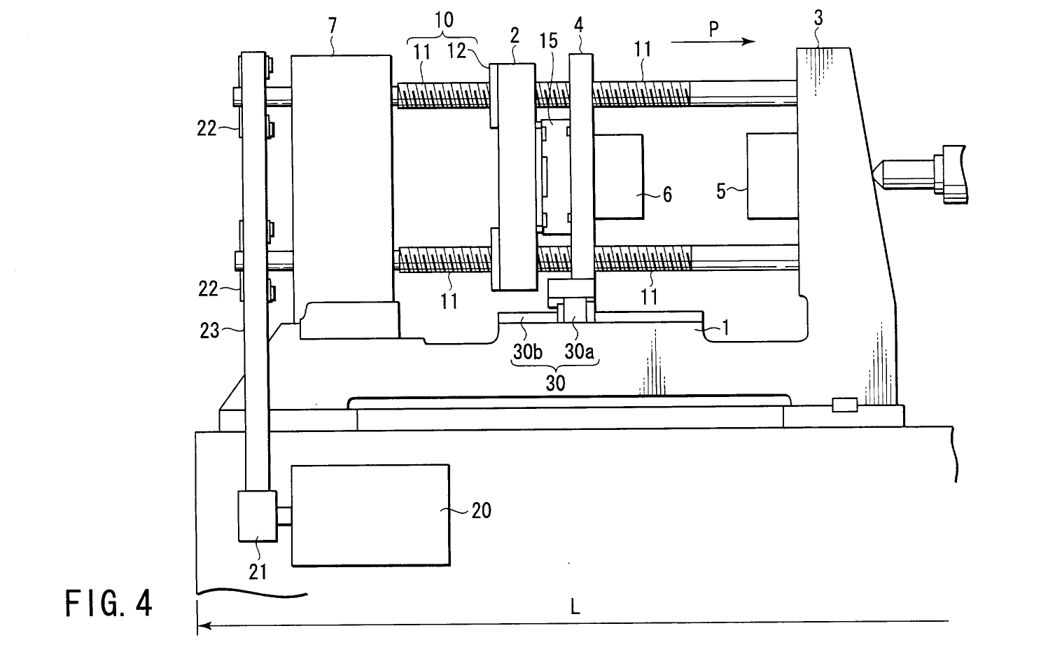

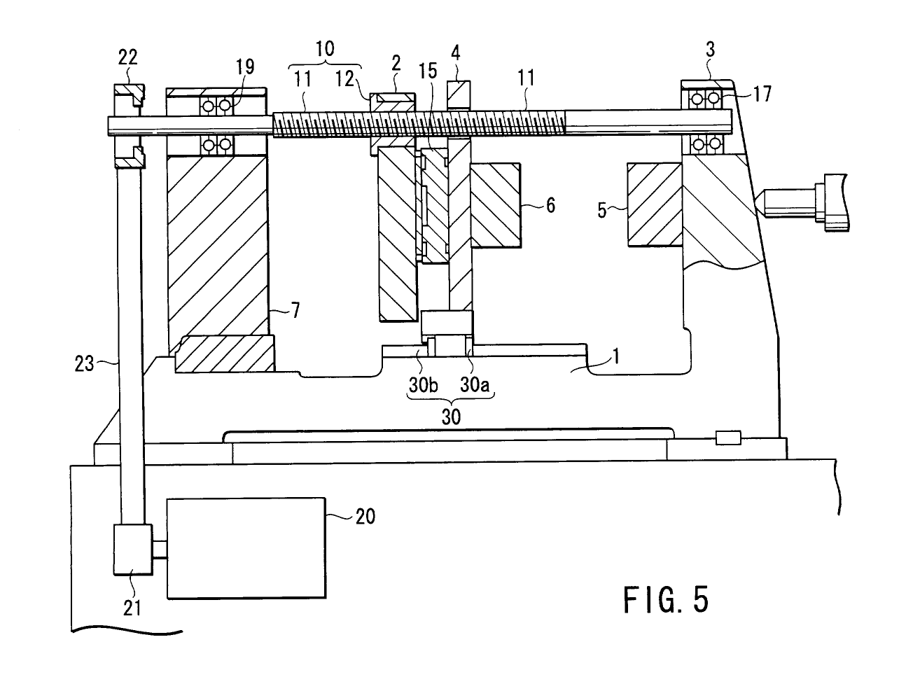

FIGS. 4 and 5 schematically show a second embodiment of a clamping unit of an injection molding machine according to the invention. FIG. 4 is a front view of the unit and FIG. 5 is a longitudinal sectional view of the unit as viewed parallel to the axial direction of the unit. In the figures, the numeral 3 indicates a stationary platen, the numeral 4 a movable platen, the numeral 5 a stationary die, the numeral 6 a movable die, the numeral 2 a backup plate, the numeral 10 a ball screw, the numeral 11 a screw shaft of the ball screw 10, and the numeral 12 a nut of the ball screw 10.

At both ends of a base 1 are fixed the stationary platen 3 and a support plate 7 opposite to each other. Between the stationary platen 3 and the support plate 7 is disposed the movable platen 4 opposite to the stationary platen 3. The stationary die 5 is held at the front face of the stationary platen 3. The movable die 6 is held at the front face of the movable platen 4. The movable platen 4 can slide on the base 1.

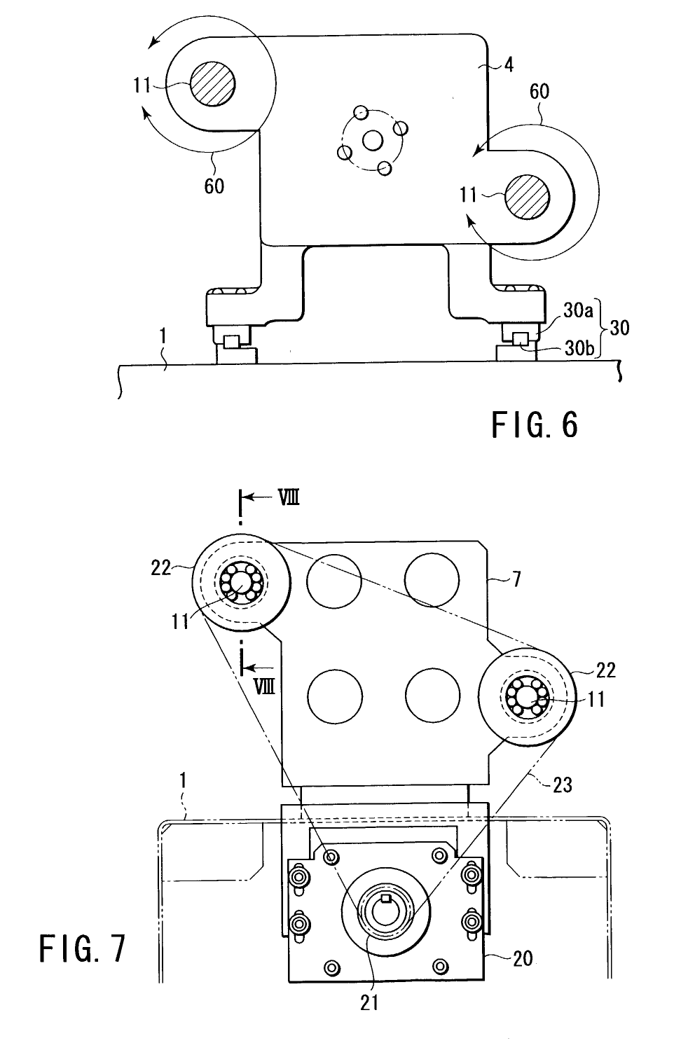

FIG. 6 shows a left-hand side view of a movable platen 4. A through hole is formed at each of two corners of the movable platen 4, which are diagonal with respect to each other. The screw shafts 11 of ball screws 10 pierce these through holes. The sliding surface on the bottom portion of the movable platen 4 is connected to a base 1 via a linear guiding system, for example, a linear guide 30, which is provided on the base 1. The linear guide 30 consists of a linear guide rail 30b provided on the base 1 and a slider 30a attached to the bottom portion of the movable platen 4. The slider 30a can sandwich the guide rail 30b from its both side faces by means of rotatable elements, such as balls and rollers. The movable platen 4, together with the slider 30a can slide linearly along the guide rail 30b.

Referring back to FIGS. 4 and 5, a backup plate 2 is disposed between the movable platen 4 and the support plate 7. The backup plate 2 can move over the base 1 in the backward and forward directions (lateral direction in the figures) along the screw shaft 11. The nut 12 of the ball screw 10 is fixed to each of two corners of the backup plate 2, which are diagonal with respect to each other. The screw shaft 11 of the ball screw 10 pierces the backup plate 2 via the nut 12. The leading end portion of the screw shaft 11 (the right-hand end portion in the figure) is rotatably connected to the stationary platen 3 via a bearing 17. The tail end portion of the screw shaft 11 (the left-hand end portion in the figure) is rotatably supported by the support plate 7 via a bearing 19 and pierces the support plate 7. The movable platen 4 is connected to the front face of the backup plate 2 via a load cell 15.

A motor 20 is housed below the base 1. A pulley 21 is attached to the shaft of the motor 20. A pulley 22 is attached to the tail end portion of the screw shaft 11 of each ball screw 10 (the left-hand end portion in the figure). A timing belt 23 bridges the pulley 21 and each of the pulleys 22.

FIG. 7 is a side view of the left-hand portion of the unit and a detailed view of a connection portion between a motor 20 and a screw shaft 11. A pulley 21 is attached to the shaft of the motor 20. A pulley 22 is attached to the tail end portion of the screw shaft 11 of each ball screw. A timing belt 23 bridges the pulley 21 and each of the pulleys 22.

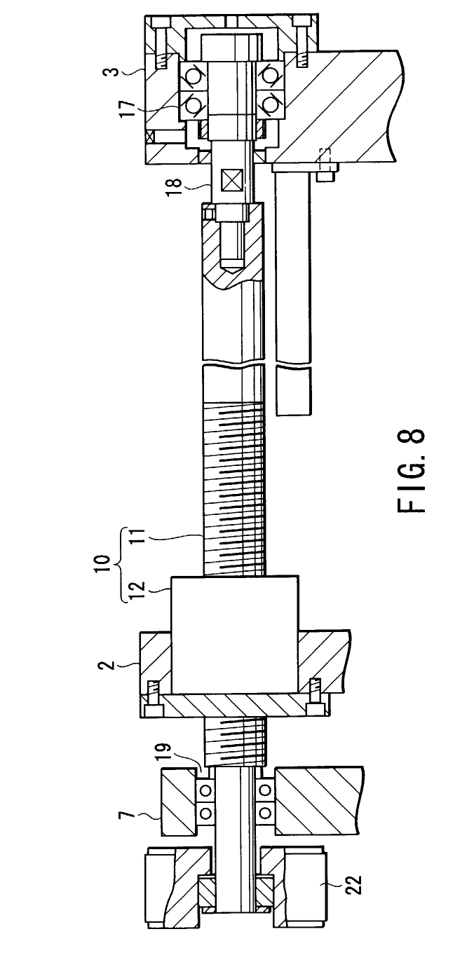

FIG. 8 is a partial detail view of a ball screw 10. This view corresponds to the section taken along the line VIII-VIII in FIG. 7. A nut 12 of the ball screw 10 is fixed to a backup plate 2. A screw shaft 11 of the ball screw 10 pierces the backup plate 2 via the nut 12. The leading end portion of the screw shaft 11 of ball screw 10 (the right-hand end portion in the figure) is rotatably connected to the front face of a stationary platen 3 via a bearing 17 and a fixing member 18. The tail end portion of the screw shaft 11 (the left-hand end portion in the figure) is rotatably supported by a support plate 7 via a bearing 19 and pierces the support plate 7. The above-described pulley 22 is attached to the tail end portion of the screw shaft 11.

Each screw shaft 11 is rotated by the rotation of the motor 20 and each nut 12 is axially driven by this rotation of the screw shaft 11. That is, the plurality of ball screws 10 is driven in synchronization with each other. In this manner the backup plate 2 moves in the forward and backward directions along the screw shaft 11. At the same time with the movement of the backup plate 2, the movable platen 4 connected to the front face of the backup plate 2 also moves. As described above, the operation of die clamping and die opening is performed by the drive of the ball screws 10.

In die clamping, the die faces of the stationary die 5 and movable die 6 are brought into contact with each other by driving the ball screws 10 and advancing the movable platen 4 toward the stationary platen 3 (in the direction indicated by P in FIG. 4). The movable die 6 receives a reaction force of the die-clamping force upon contact, which is transmitted to the screw shaft 11 of the ball screw 10 through the movable platen 4, load cell 15 and backup plate 2 in this order.

Also in the clamping unit of this embodiment, as shown in FIG. 6, the movable platen 4 slides by means of the linear guide 30 provided on the base 1. As described above, the slider 30a of the linear guide 30 sandwiches the guide rail 30b from its both side faces. For this reason, the movable platen 4 moves only in the sliding direction along the guide rail 30b. Therefore, differently from the case where the guide face comprises a sliding plate, the linear guide 30 can restrain a torsional moment generated in the movable platen 4. The torsional moment is generated on the backup plate 2 in both rotative directions by the forward and reverse rotations of the ball screw 11. After that, the torsional moment is transmitted to the movable platen 4 via the load cell 15.

As a result of the restraint of the torsional moment of the movable platen 4, the same effects as with the first embodiment are obtained; for example, an accurate die-clamping force is obtained.

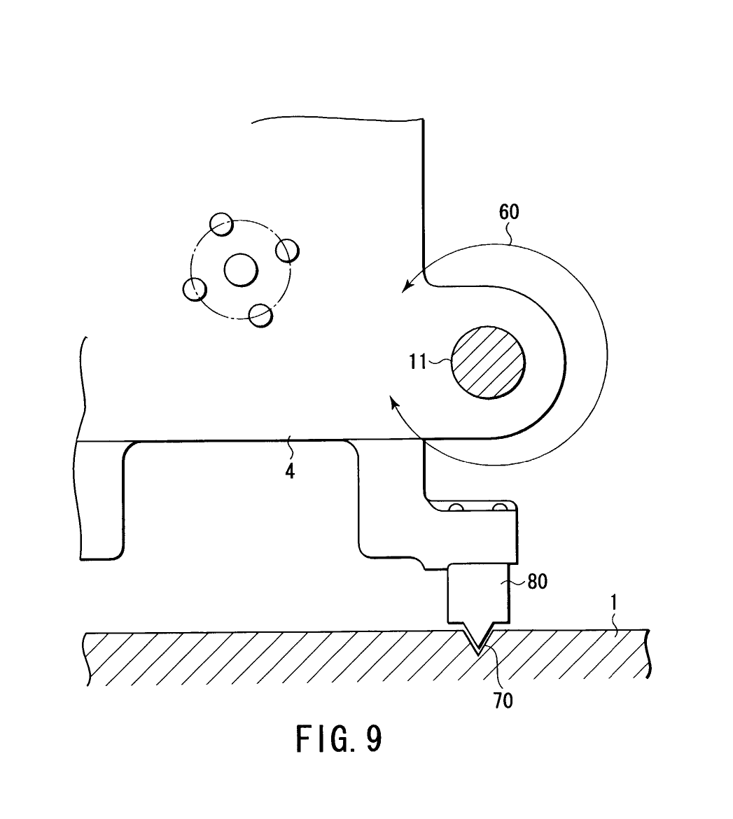

As shown in FIG. 9, the linear guide 30 as the linear guiding system may be replaced by a linear guide groove 70 provided on the surface of the base 1 and a member 80 attached to the bottom portion of the movable platen 4. The guide groove 70 is, for example, a V-shaped groove. The member 80 has a convex portion corresponding to the guide groove 70, such as a V-shaped section. The convex portion of the convex member 80 is inserted into the guide groove 70 and slid along the groove 70. In this manner it is possible to cause the movable platen 4 to slide linearly along the guide groove 70. Also in this case, the torsional moment generated by the rotation 60 of the ball screw 11 can be restrained by the guide groove 70. For this reason, the above-described effects are produced; for example, an accurate die-clamping force is obtained.

Incidentally, the movable platen 4 can be directly connected to the front face of the backup plate 2 by omitting the load cell 15 shown in FIGS. 4 and 5. In this case, it is also possible to integrate the backup plate 2 and the movable platen 4 into one piece. When the load cell 15 is omitted, the twist and the like due to the rotation of the ball screw 10 cannot be absorbed between the load cell 15 and the movable platen 4 or between the load cell 15 and the backup plate 2. For this reason, the effect of the use of a linear guiding system, for example, the linear guide 30 as the guide of the movable platen 4 can be increased.

Moreover, it is also possible to allow the screw shaft 11 of the ball screw 10 to function as a tie rod. As a result, the structure of the unit can be simplified.

It is preferred that the stationary platen 3 and the backup plate 2 be connected together by two ball screws 10. These ball screws 10 are disposed in diagonal positions, with the center axis of the stationary die 5 and movable die 6 positioned in the middle. One of the ball screws 10 is disposed over the center axis, and the other below the center axis.

It is also possible to dispose the two ball screws 10 in this manner and at the same time to give the function of a tie rod to these ball screws 10. As a result, the number of parts disposed around the dies 5, 6 decreases and hence access to the dies becomes easy.

Furthermore, in the clamping unit of the invention, the screw shaft 11 of the ball screw 10 only rotates and does not move axially. For this reason, it is unnecessary to prepare an open space behind the unit to receive the screw shaft 11 moved backward. Therefore, it is possible to shorten the total length of the unit (L in FIG. 4).

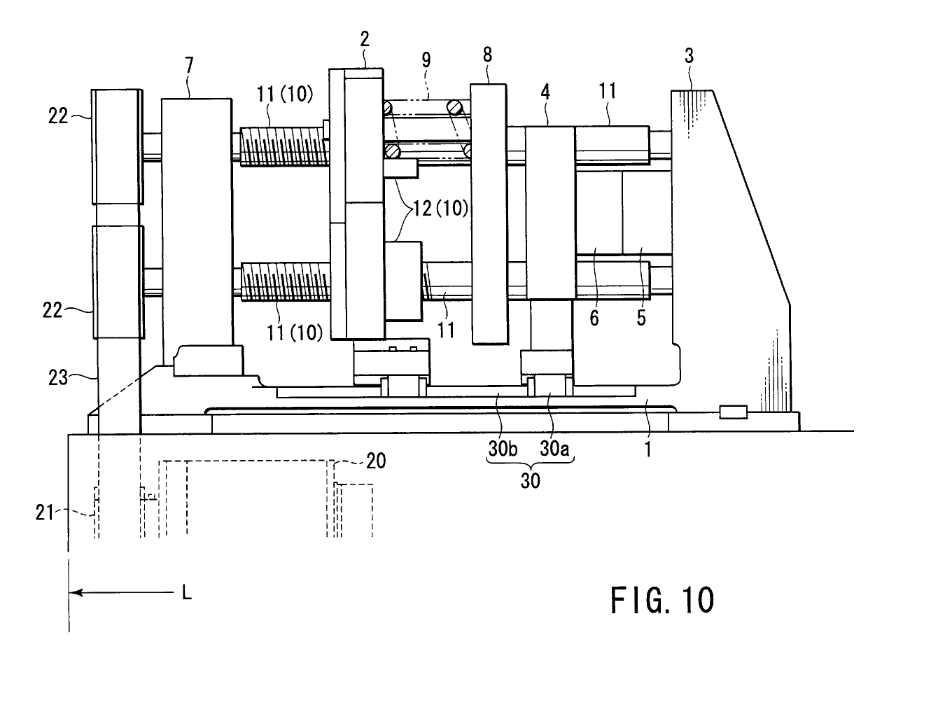

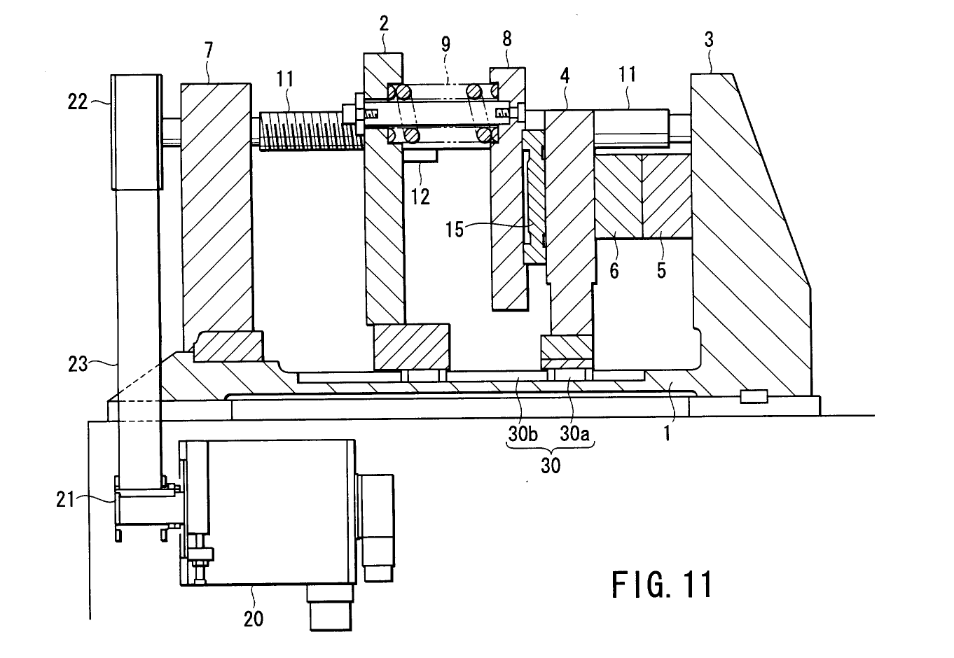

FIGS. 10 and 11 schematically show a third embodiment of a clamping unit of the invention. FIG. 10 is a front view of the unit and FIG. 11 is a longitudinal sectional view of the unit parallel to its axial direction.

A stationary platen 3 and a support plate 7 are fixed to both ends of a base 1. Between the stationary platen 3 and the support plate 7 is disposed a movable platen 4 opposite to the stationary platen 3. A stationary die 5 is held by the stationary platen 3. A movable die 6 is held by the movable platen 4. Between the movable platen 4 and the support plate 7 is disposed a backup plate 2. The movable platen 4 and backup plate 2 can slide on the base 1. Via a nut 12 of a ball screw 10 fixed to the backup plate 2, a screw shaft 11 of the ball screw 10 pierces the backup plate 2. The leading end portion of the ball screw 11 (the right-hand end portion in FIGS. 10 and 11) is rotatably connected to the stationary platen 3 via a bearing (not shown). The tail end portion of the screw shaft 11 (the left-hand end portion in FIGS. 10 and 11) is rotatably supported by the support plate 7 via a bearing (not shown) and pierces the support plate 7. The backup plate 2 and movable platen 4 are connected together via four coil springs (elastic members) 9 and a spring-receiving member 8. A motor 20 is housed under the base 1. A pulley 21 is attached to the shaft of the motor 20. A pulley 22 is attached to the tail end portion of each screw shaft 11. A timing belt 23 bridges the pulley 21 and each of the pulleys 22.

As with the second embodiment, as shown in FIG. 6, the screw shafts 11 of the ball screws 10 pierce the through holes at two corners of the movable platen 4. The movable platen 4 slides on the base 1 by means of a linear guiding system, for example, a linear guide 30, which is provided on the base 1. The linear guide 30 comprises a slider 30a and a guide rail 30b.

The motor 20 and the screw shaft 11 are connected together in the same manner as shown in FIG. 7. The details of the ball screw are the same as those shown in FIG. 8.

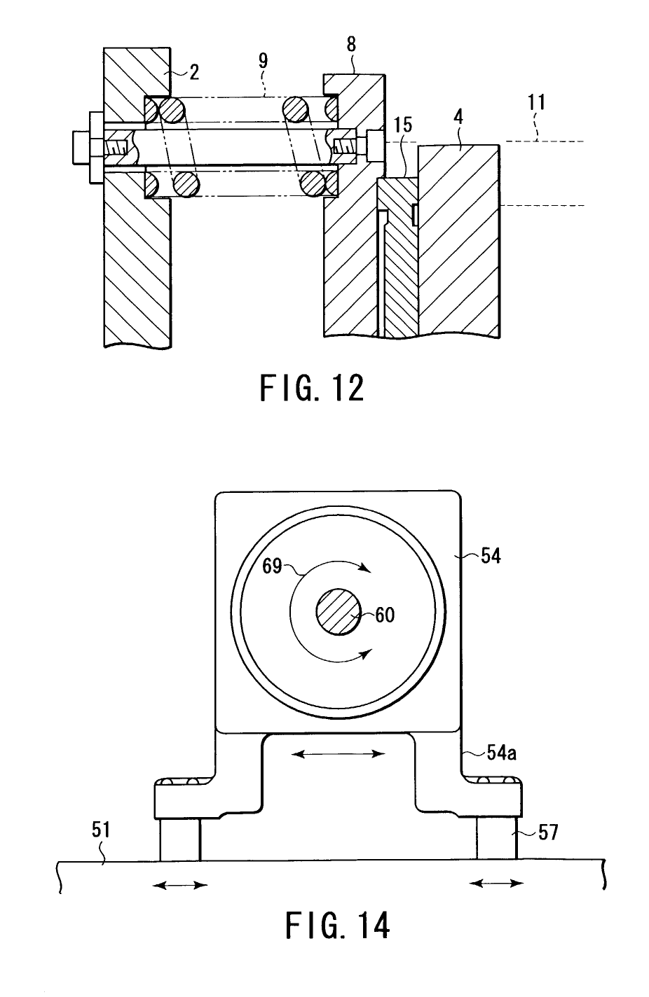

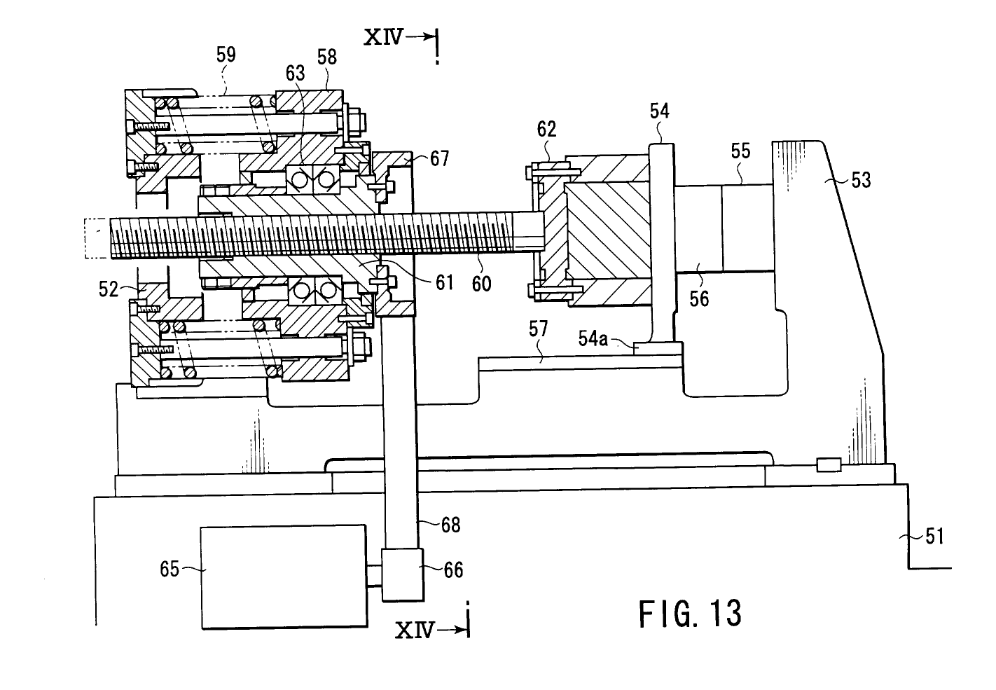

FIG. 12 shows the details of a connection portion between the backup plate 2 and the movable platen 4. The spring-receiving member 8 is attached to the rear face of the movable platen 4 via a load cell 15. The spring-receiving member 8 is connected to the backup plate 2 via the four coil springs 9.

Also in the clamping unit of this embodiment, the screw shafts 11 rotate in synchronization with each other by the rotation of the motor 20, and each nut 12 is axially driven. As a result, the backup plate 2 moves along the screw shafts 11 in the forward and backward directions with respect to the stationary platen 3. With the movement of the backup plate 2, the movable platen 4, which is connected to the front face of the backup plate 2 via the coil springs 9, also moves. In this manner the operation of die clamping and die opening is performed by the drive of the ball screws 10.

Also in the clamping unit of this embodiment, as shown in FIG. 6, the movable platen 4 slides by means of the linear guide 30 provided on the base 1. Therefore, the linear guide 30 can restrain a torsional moment generated by the rotation of the ball screw 11. As a result, the above-described effects are produced; for example, an accurate die-clamping force is obtained. Furthermore, as described by referring to FIG. 9, the linear guide 30 can be replaced by the guide groove 70 provided on the surface of the base 1, and the member 80 having a convex portion to be inserted into the guide groove 70. They can also slide the movable platen 4 to provide the same effect as with the linear guide 30.

Also in this embodiment, as with the second embodiment, the movable platen 4 can be directly connected to the front face of the spring-receiving member 8 by omitting the load cell 15 shown in FIGS. 11 and 12. In this case, it is also possible to integrate the spring-receiving member 8 and the movable platen 4 into one piece. When the load cell 15 is omitted, the twist and the like due to the rotation of the ball screw 10 cannot be absorbed between the load cell 15 and the movable platen 4, or between the load cell 15 and the spring-receiving member 8. For this reason, the effect of the use of a linear guiding system, for example, the linear guide 30 as the guide of the movable platen 4 can be increased.

Also in this embodiment, as with the second embodiment, the screw shaft 11 of the ball screw 10 only rotates and does not move axially. For this reason, it is unnecessary to prepare an open space behind the unit to receive the screw shaft 11 moved backward. Therefore, it is possible to shorten the total length of the unit (L in FIG. 4).

Incidentally, in this embodiment, when the die faces of the stationary die 5 and movable die 6 are brought into contact with each other during die clamping, the movable die 6 receives a reaction force of the die-clamping force, which is transmitted to the screw shaft 11 of the ball screw 10 through the movable platen 4, load cell 15, spring-receiving member 8, coil spring 9 and backup plate 2 in this order. In this manner the screw 11 elongates elastically and, at the same time, the coil spring 9 contracts.

Appropriate design of the spring constant of the coil spring 9 can make the elastic contraction generated in the coil spring 9 larger than the elongation of the screw shaft 11. As a result, it is possible to increase the elongation of the screw shaft 11 to which the reaction force has been transmitted, in comparison with the case where the reaction force of the die clamping is received only by four tie rods (of which the rigidity is high because the total sectional area is large). For this reason, when the die faces of the stationary die 5 and movable die 6 come into contact with each other, the die-clamping force can increase more slowly so that the control resolution of the die-clamping force can be improved. As a result, the overshoot of the die-clamping force can be prevented and the accuracy of the die-clamping force can be raised. Also, excessive loads can be prevented from acting on the components of the clamping unit and, therefore, the life of these components can be extended.

As described above, in the clamping unit of the invention, the movable platen is moved by use of a linear guiding system, for example, a linear guide, which is provided on the base. As a result, the twist (rotation) and lateral shift of the movable platen do not occur any more and an accurate die-clamping force can be obtained. Furthermore, during die clamping, the movable die does not rotate along with the movable platen. Therefore, neither a deviation between the two dies nor rubbing or biting of the dies occurs, and die life can be extended. Moreover, because the movable die does not rotate during die clamping, stable precision molding becomes possible.

Also, in the clamping unit of the invention, during die clamping and die opening, the screw shaft of the ball screw only rotates and does not move axially. As a result, it is unnecessary to prepare an open space behind the unit to receive the screw shaft moved backward and, therefore, the total length of the unit can be shortened.

Also, in the present invention, the stationary platen and the backup plate can be connected together by means of two ball screws. These ball screws are disposed in diagonal positions, with the center axis of the stationary die and movable die positioned in the middle. One of the ball screws 10 is disposed over the center axis, and the other below the center axis. In addition, it is also possible to give the function of a tie rod to these ball screws. As a result, the number of parts, such as rods, which are disposed around the dies can be reduced and hence access to the dies becomes easy.

Moreover, loads such as the die-clamping force on the ball screw can be distributed by using a plurality of ball screws. For this reason, the size of the ball screw can be reduced.

Furthermore, it is possible to connect the stationary platen and the backup plate by use of a ball screw and at the same time to connect the backup plate and the movable platen via elastic members. As a result, during die-clamping, the die-clamping force can increase more slowly so that the control resolution of the die-clamping force can be improved. As a result, the overshoot of the die-clamping force can be prevented and the accuracy of the die-clamping force can be raised. Also, excessive loads can be prevented from acting on the components of the clamping unit and, therefore, the life of these components can be extended.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clamping unit for die clamping with a die-clamping force directly applied to dies consisting of a stationary die and a movable die, comprising:
a stationary platen for holding said stationary die;
a movable platen for holding said movable die, said movable platen being disposed opposite to said stationary platen; and
a linear guiding system for guiding the movement of said movable platen.

2. A clamping unit for die clamping with a die-clamping force directly applied to dies consisting of a stationary die and a movable die, comprising:
a base;
a stationary platen for holding said stationary die, said stationary platen being disposed on one side of said base;
a movable platen for holding said movable die, said movable platen being disposed opposite to said stationary platen;
a linear guiding system for guiding the movement of said movable platen, said linear guiding system being provided on said base;
a backup plate disposed on the other side of said base;
a housing disposed in front of said backup plate;
an elastic member for connecting said backup plate and said housing, said elastic member being capable of expansion and contraction in the die-clamping direction;
a ball screw for connecting said housing and said movable platen, said ball screw having a screw shaft of which the leading end is fixed to the rear face of said movable platen and a nut rotatably housed in said housing; and
a motor for rotating said nut of the ball screw housed in said housing.

3. A clamping unit for die clamping with a die-clamping force directly applied to dies consisting of a stationary die and a movable die, comprising:
a base;
a stationary platen for holding said stationary die, said stationary platen being disposed on said base;
a movable platen for holding said movable die, said movable platen being disposed opposite to said stationary platen;
a linear guiding system for guiding the movement of said movable platen, said linear guiding system being provided on said base;
a backup plate for supporting said movable platen at the rear face;
a plurality of ball screws for connecting said stationary platen and said backup plate, each ball screw having a screw shaft of which the leading end is rotatably connected to said stationary platen and a nut fixed to said backup plate; and
a motor for rotating said screw shafts of the plurality of ball screws in synchronization with each other.

4. A clamping unit for die clamping with a die-clamping force directly applied to dies consisting of a stationary die and a movable die, comprising:
a base;
a stationary platen for holding said stationary die, said stationary platen being disposed on said base;
a movable platen for holding said movable die, said movable platen being disposed opposite to said stationary platen;
a linear guiding system for guiding the movement of said movable platen, said linear guiding system being provided on said base;
a backup plate disposed at the rear of said movable platen;
an elastic member for connecting said movable platen and said backup plate, said elastic member being capable of expansion and contraction in the die-clamping direction;
a plurality of ball screws for connecting said stationary platen and said backup plate, each ball screw having a screw shaft of which the leading end is rotatably connected to said stationary platen and a nut fixed to said backup plate; and
a motor for rotating said screw shafts of the plurality of ball screws in synchronization with each other.

5. The clamping unit according to claim 1, wherein said linear guiding system is a linear guide, said linear guide comprising a linear guide rail provided on the base and a slider which sandwiches both side faces of said guide rail by means of rotatable elements, and wherein said slider is attached to the bottom portion of said movable platen.

6. The clamping unit according to claim 2, wherein said linear guiding system is a linear guide, said linear guide comprising a linear guide rail provided on the base and a slider which sandwiches both side faces of said guide rail by means of rotatable elements, and wherein said slider is attached to the bottom portion of said movable platen.

7. The clamping unit according to claim 3, wherein said linear guiding system is a linear guide, said linear guide comprising a linear guide rail provided on the base and a slider which sandwiches both side faces of said guide rail by means of rotatable elements, and wherein said slider is attached to the bottom portion of said movable platen.

8. The clamping unit according to claim 4, wherein said linear guiding system is a linear guide, said linear guide comprising a linear guide rail provided on the base and a slider which sandwiches both side faces of said guide rail by means of rotatable elements, and wherein said slider is attached to the bottom portion of said movable platen.

9. The clamping unit according to claim 1, wherein said linear guiding system is a linear V-shaped groove having a V-shaped section provided on the base, and wherein said V-shaped groove receives a convex member having a V-shaped section provided on said movable platen.

10. The clamping unit according to claim 2, wherein said linear guiding system is a linear V-shaped groove having a V-shaped section provided on the base, and wherein said V-shaped groove receives a convex member having a V-shaped section provided on said movable platen.

11. The clamping unit according to claim 3, wherein said linear guiding system is a linear V-shaped groove having a V-shaped section provided on the base, and wherein said V-shaped groove receives a convex member having a V-shaped section provided on said movable platen.

12. The clamping unit according to claim 4, wherein said linear guiding system is a linear V-shaped groove having a V-shaped section provided on the base, and wherein said V-shaped groove receives a convex member having a V-shaped section provided on said movable platen.
